(19) United States
(12) Patent Application Publication
(10) Pub. No.: US 2004/0137957 A1
(43) Pub. Date: Jul. 15, 2004

(54) Mobile communication terminal with built-in digital camera and photographing method using the same

(75) Inventor: Won-Bae Jeong, Yongin-city (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/742,662

(22) Filed: Dec. 19, 2003

(30) Foreign Application Priority Data
Dec. 26, 2002 (KR) 2002-84221

(51) Int. Cl. H04M 1/00; H04B 1/38

(52) U.S. Cl. 455/566; 455/550.1

(57) ABSTRACT

A mobile communication terminal with a built-in digital camera is disclosed. The mobile communication terminal comprises a liquid crystal display (LCD) for displaying various operation states of the terminal and photographed images and a camera module including an imaging device. The LCD and the imaging device are formed on a display unit allowing the camera module to process image data detected by the imaging device to generate RGB data, and the RGB data to be directly provided to the LCD.

### PRIORITY

This application claims priority to an application entitled “MOBILE COMMUNICATION TERMINAL HAVING DIGITAL CAMERA THEREIN AND METHOD OF PHOTOGRAPHING USING THE DIGITAL CAMERA” filed in the Korean Intellectual Property Office on Dec. 26, 2002 and assigned as Serial No. 2002-84221, the contents of which are incorporated herein by reference.

### BACKGROUND OF THE INVENTION

1. Field of the Invention

The present invention relates to a portable composite mobile communication terminal, and more particularly, to a mobile communication terminal with built-in digital camera and a photographing method using the same.

2. Description of the Related Art

Recently, with the rapid advances of our information-oriented society, there is an increasing demand for development of a composite mobile communication terminal with various functions as well as audio transmission. Therefore, to keep pace with our multimedia era, portable composite mobile communication terminals with image and audio reception/transmission functions have been widely spread. Among the composite mobile communication terminals, camera phones having a digital camera module connected to a portable mobile communication terminal that users usually carry are becoming typical.

Using the mobile communication terminal to which the digital camera is connected, users can photograph certain scenes or moving pictures at any time and can store the photographed images in the terminal. The photographed images can be transmitted to other terminals via the mobile communication terminal. In addition, the photographed images can be displayed on the screen of a personal computer (PC) or stored in PCs through an external connection.

Meanwhile, there have been recently developed communication terminals (so-called “TV phone”) that can receive and display TV broadcasting programs, mobile communication terminals that can download Internet information through a connection with Internet, and terminals that can display moving pictures. In addition, next-generation mobile communication terminals (IMT-2000) that can perform all the above functions have been developed and are becoming widely available.

FIG. 1 is a block diagram of a conventional mobile communication terminal with a detachable digital camera. Referring to FIG. 1, the conventional mobile communication terminal with the detachable digital camera includes a terminal main body 120 and a digital camera module 110 detachable from the terminal main body 120. Like a general mobile communication terminal, the terminal main body 120 includes a radio signal transmission/reception unit 126 for transmitting/receiving radio signals, a liquid crystal display (LCD) 127, a user interface unit 128 that can be provided with a plurality of numeric keys or various function keys or a touch screen, and a mobile station modem (MSM) 124 for controlling overall operations of the terminal.

The digital camera module 110 typically includes: a lens unit 111 for receiving light signals from a subject; a charge coupled device (CCD) 112 (or complementary metal oxide semiconductor (CMOS) device) for converting the light signals inputted via the lens unit 111 into electric signals having the brightness and color values of red, green and blue (RGB), and for outputting the signals; a correlated double sampling/auto gain control (CDS/AGC) unit 113 for performing a correlated double sampling with respect to the signals outputted from the CCD 112 and for performing a gain control thereof; an analog-to-digital converter (ADC) 114 for converting the signals outputted from the CDS/AGC unit 113 into digital signals; an image processing unit 115 for performing such an image processing operations as a gamma correction and a color calibration, with respect to the signals outputted from the ADC 114 to generate image signals (Y, C or YUV) of national television system committee (NTSC) or phase alternation by line (PAL); a joint picture expert group (JPEG) chipset 116 for performing JPEG process with respect to the signals outputted from the image processing unit 115, and for storing the processed signals or transmitting the processed signals to a camera control unit 117; and the camera control unit 117 for controlling overall operations of the digital camera module 110.

Such a digital camera module 110 is typically provided as a separate module, and is generally detachably connected to the terminal main body 120. At this time, in order to connect the digital camera module 110 to the terminal main body 120, a connector unit 119 and a data input/output unit 122 are provided in the digital camera module 110 and the terminal main body 120, respectively. The image signals (Y, C or YUV) photographed and signal-processed in the digital camera module 110 are provided to the terminal main body 120 via the connector unit 119 and the data input/output unit 122 so that they can be displayed on the LCD 127 of the terminal main body 120.

The conventional mobile communication terminal has a separate camera module. Thus, additional connection units are required to connect the separate camera module to the mobile communication terminal, making it difficult to satisfy the demands for miniaturization and reduction in weight. In addition, there are problems of signal degradation and introduction of noise when image signals are transmitted from the camera module to the mobile communication terminal.

### SUMMARY OF THE INVENTION

Accordingly, an object of the present invention is to provide a mobile communication terminal with a built-in digital camera, in which additional connection units are not needed and the demands for miniaturization and reduction in weight are satisfied.

Another object of the present invention is to provide a mobile communication terminal with a built-in digital camera, capable of preventing the degradation of image signals generated by the camera and the introduction of noise.

Additional advantages, objects, and features of the invention will be set forth in part in the description which follows as will be apparent to those of ordinary skill in the art. The objects and other advantages of the invention may be realized and attained by the structure particularly pointed out in the written description and claims thereof as well as the appended drawings.

To achieve these objects and other advantages in accordance with the purpose of the present invention, as embodied and broadly described herein, there is provided a mobile communication terminal with a built-in digital camera. The mobile communication terminal of the present invention comprises a liquid crystal display (LCD) for displaying various operation states of the terminal and photographed images and a camera module including an imaging device. The LCD and the imaging device are formed on a display unit allowing the camera module to process image data detected by the imaging device to generate RGB data, and the RGB data to be directly provided to the LCD.

### BRIEF DESCRIPTION OF THE DRAWINGS

The accompanying drawings, which are included to provide a further understanding of the invention and are incorporated herein and constitute a part of this application, illustrate embodiment(s) of the invention and together with the description serve to explain the principle of the invention. In the drawings:

FIG. 1 is a block diagram of a conventional mobile communication terminal with a detachable digital camera;

FIG. 2 is a block diagram of a mobile communication terminal with a built-in digital camera in accordance with an embodiment of the present invention;

FIG. 3 is a schematic diagram of a display unit in which the digital camera module and the liquid crystal display are provided;

FIG. 4 is a block diagram of the digital camera module and related components;

FIG. 5 is a block diagram of a digital camera module and related components in accordance with another embodiment of the present invention; and

FIG. 6 is a flowchart of a photographing method in the mobile communication terminal with the built-in digital camera module in accordance with an embodiment of the present invention.

### DETAILED DESCRIPTION OF THE INVENTION

Reference will now be made in detail to the preferred embodiments of the present invention, examples of which are illustrated in the accompanying drawings. It will be apparent to those skilled in the art that various modifications and variations can be made in the present invention. Thus, it is intended that the present invention covers the modifications and variations of this invention within the scope of the present invention.

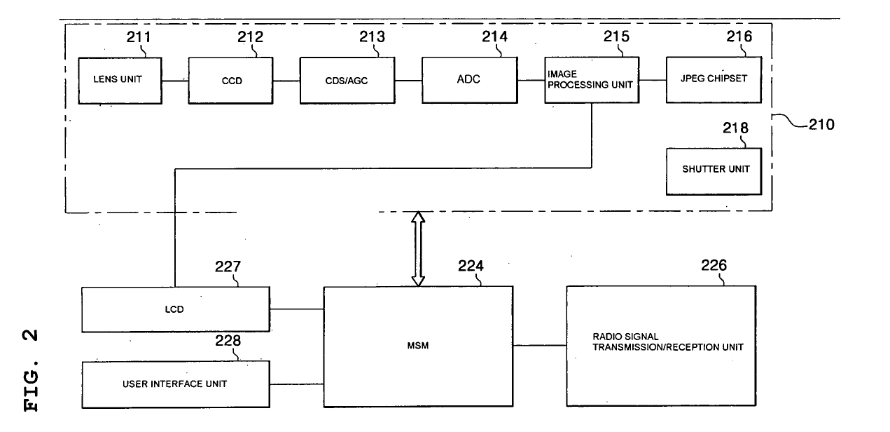

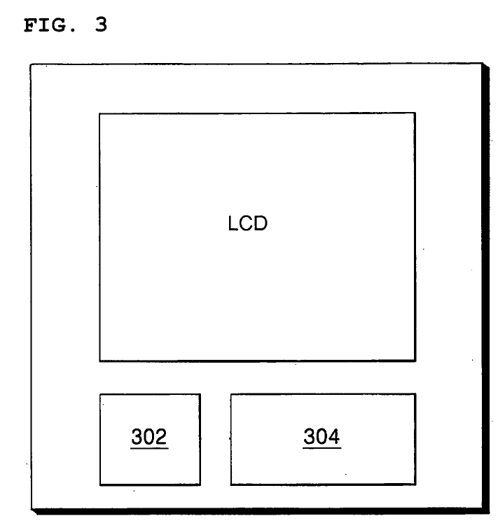

FIG. 2 is a block diagram of a mobile communication terminal with a built-in digital camera in accordance with an embodiment of the present invention. FIG. 3 is a schematic diagram of a display unit in which a digital camera module and an LCD are provided. Referring to FIGS. 2 and 3, the camera module 210 is installed in a terminal main body. An imaging device of the camera module 210 and LCD 227 are provided in the display unit.

In FIG. 3, below the LCD, there are shown an area 302 in which the camera module's imaging device (i.e., CCD or CMOS devices) is provided, and an area 304 in which a driving circuit for driving the LCD and the camera module is provided. The LCD and the CCD or CMOS devices may be manufactured by a separate semiconductor process or may be simultaneously manufactured on the same substrate through semiconductor process.

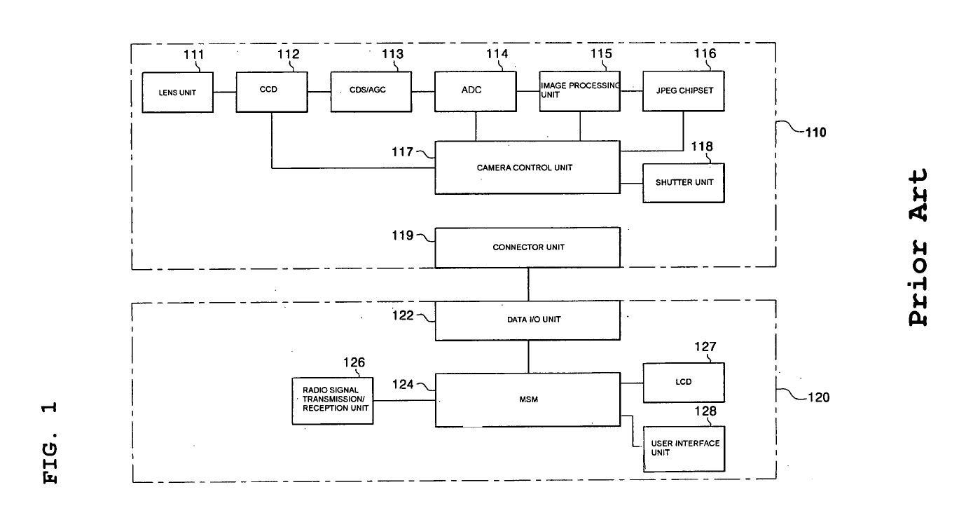

Referring again to FIG. 2, like the conventional mobile communication terminal, the mobile communication terminal with the built-in digital camera in accordance with the present invention includes a radio signal transmission/reception unit 226 for transmitting/receiving radio signals, a liquid crystal display (LCD) 227, a user interface unit 228 that can be provided with a plurality of numeric keys or various function keys or a touch screen, and a mobile station modem (MSM) 224 for controlling overall operations of the terminal. In addition, the mobile communication terminal with the built-in digital camera includes a digital camera module 210 for performing a camera function in accordance with the present invention. The MSM 224 also functions as the conventional camera control unit (117 in FIG. 1) so that it controls the overall operations of the camera module 210.

Similar to the related art, the digital camera module 210 includes: a lens unit 211 for receiving light signals from a subject; a charge coupled device (CCD) 212 (or complementary metal oxide semiconductor (CMOS) device) for converting the light signals inputted via the lens unit 211 into electric signals having brightness and color values of red, green and blue (RGB) colors, and for outputting the signals; a correlated double sampling/auto gain control (CDS/AGC) unit 213 for performing a correlated double sampling with respect to the signals outputted from the CCD 212 and for performing a gain control thereof; an analog-to-digital converter (ADC) 214 for converting the signals outputted from the CDS/AGC unit 213 into digital signals; an image processing unit 215 for performing the image processing operations, such as gamma correction and color calibration, with respect to the signals outputted from the ADC 214 to generate image signals (Y, C or YUV) of national television system committee (NTSC) or phase alternation by line (PAL); and a joint picture expert group (JPEG) chipset 216 for performing JPEG process with respect to the signals outputted from the image processing unit 215 and storing the processed signals or transmitting the processed signals to the MSM 224. In accordance with the present invention, the image processing unit 215 directly transmits the RGB data which have been processed using the gamma correction and the color calibration, to the LCD 227, so that the images corresponding to the RGB data can be displayed on the LCD 227.

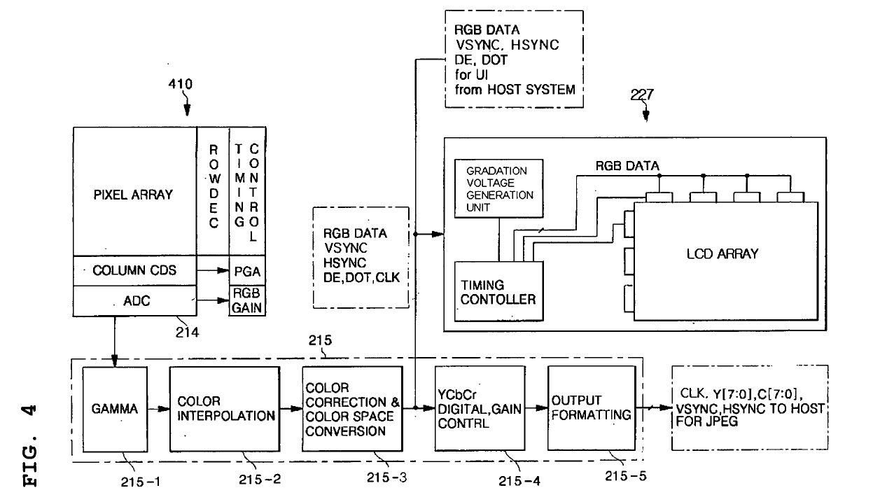

Hereinafter, the structure and operation for directly transmitting the RGB data from the image processing unit 215 to the LCD 227 will be described in detail with reference to FIG. 4.

FIG. 4 is a block diagram of the digital camera module and related components. Referring to FIG. 4, a CCD device 410 includes the lens unit 211, the CCD 212, the CDS/AGC 213 and the ADC 214, which are contained in the digital camera module 210 (as shown in FIG. 2). Signals outputted from the ADC 214 of the CCD device 410 are inputted to the image processing unit 215. In the image processing unit 215, a gamma correction unit 215-1 performs the gamma correction with respect to the signals outputted from the ADC 214, and a color interpolation unit 215-2 then performs a color interpolation. Thereafter, a color correction unit 215-3 performs a color correction to generate the RGB data. RGB data, VSYNC, HSYNC, DE, DOT and CLK are data as provided from the color correction unit 215-3 to the LCD, to directly display the image data on the LCD. RGB data, VSYNC, HSYNC, DE and DOT are data as provided from the host system to the LCD, to display User Interface (UI) picture (memo) on the LCD. A component signal gain control unit 215-4 controls the gain of the RGB data, and the image signal output formatting unit 215-5 outputs the data converted into the component signals, i.e., Y (luminance), Cb (color difference signal=B−Y) and Cr (color difference signal=R−Y). CLK, Y[7:0], C[7:0], VSYNC and HSYNC are data as provided from the image signal output formatting unit 215-5 to the host system or camera back-end chip, to convert the image data into JPEG file. Of course, the image processing unit 215 can convert the image signals not into component image signals as shown in FIG. 4 but into composite image signals, i.e., YUV [Y (luminance signal)+UV (color signal)]. The RGB data outputted from the color correction unit 215-3 of the image processing unit 215 are directly transmitted to the LCD 227 to display the photographed image. The gradation voltage generation unit converts the RGB data as received from the host system, into analog data according to the degree in which the liquid crystal has been twisted.

The image data detected by a CCD pixel array of the CCD device 410 are processed through the ADC 214 and the gamma correction unit 215-1 to generate the RGB data. The RGB data can be directly transmitted to the LCD without being processed by either the component signal gain control unit 215-4 or the image signal output formatting unit 215-5, for preview. Thus, since the RGB data are directly transmitted from the digital camera module 210 to the LCD, the photographed images can be displayed almost in real time. In addition, the data converted into YUV or YCbCr for JPEG are transmitted to a digital signal processor (DSP) or the host system (i.e., the MSM 224) (not shown in FIG. 4). At this time, in the event that the digital camera module 210 does not work, the host system provides the RGB data to the LCD 227.

In accordance with the present invention, a fast frame rate can be obtained more easily than in the conventional art which needs additional image processing devices.

Since the digital camera module 210 is provided in the display unit, the area occupied by the conventional externally detachable camera module is remarkably reduced in view of the design, thereby achieving a miniaturization and a reduction in weight.

In addition, data lines between the digital camera module 210 and the LCD 227 can be processed within a chip or between the panel glasses having a short space. Consequently, the introduction of noise into the system can be reduced and data lines required can be remarkably reduced.

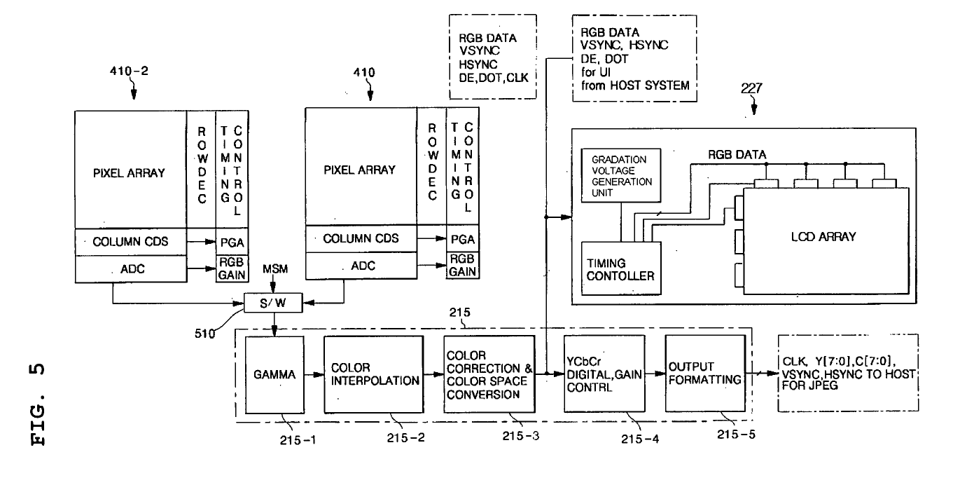

Other embodiments of the present invention will be described in detail with reference to FIG. 5.

FIG. 5 is a block diagram of a digital camera module and related components in accordance with another embodiment of the present invention. Referring to FIG. 5, the digital camera module in accordance with another embodiment of the present invention further includes an additional imaging device array as well as the basic imaging device array (i.e., the CCD device 410) shown in FIG. 4. In other words, as shown in FIG. 5, the additional CCD device 410-2 is separately provided as well as the basic CCD device 410. In addition, there is further provided a switch 510 for selectively switching between the signals outputted from the basic CCD device 410 and the signals outputted from the additional CCD device 410-2. A switching operation of the switch 510 is controlled by the MSM 224. In a camera photographing mode, the MSM 224 outputs a control signal to the switch 510 in response to a proper manipulation of the user, so that the switch 510 provides the image processing unit 215 with the signals outputted from either the basic CCD device 410 or the additional CCD device 410-2.

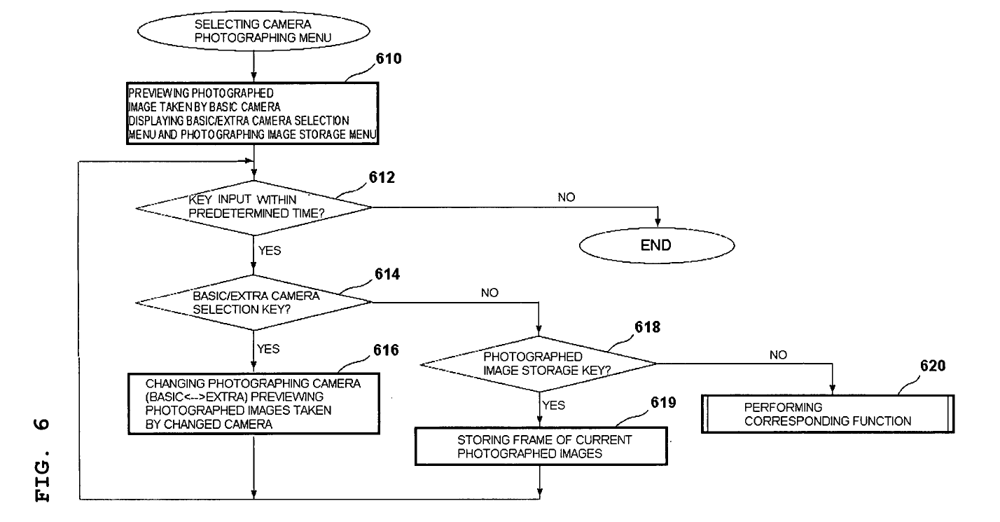

The basic CCD device 410 and the additional CCD device 410-2 are disposed at different positions on the mobile communication terminal so that it is possible to photograph the scenes in different directions. For example, in case that the mobile communication terminal is a folder type, the basic CCD device 410 is disposed at the display unit within the folder and the additional CCD device 410-2 is disposed at the outer side of the folder. At this time, it is desirable that the basic CCD device 410 and the additional CCD device 410-2 be positioned facing away from each other with respect to the folder, i.e. facing in opposite directions. Thus, the user can selectively set the photographing direction of the camera module, i.e., the inward or outward direction of the folder. Such an operation will be described below in detail with reference to FIG. 6.

FIG. 6 is a flowchart of a photographing method of the mobile communication terminal with the built-in digital camera module in accordance with an embodiment of the present invention. FIG. 6 shows the case that both the basic CCD device 410 and the additional CCD device 410-2 are installed in the mobile communication terminal. First, the mobile communication terminal has a camera photographing menu of the present invention and the user can select the camera photographing menu through the user interface unit 228. After the user selects the camera photographing menu, in the step 610, the MSM 224 of the mobile communication terminal previews the photographed images taken by the basic camera (i.e., the basic CCD device 410). In addition, the MSM 224 displays a basic/extra camera selection menu guiding the manipulation of changing the camera to be used and a photographed image storage menu guiding a manipulation of storing the photographed images which are being currently taken. At this time, the user can request desired functions by inputting function keys that are previously set for the camera change manipulation or the image storage manipulation. The MSM 224 can be in a standby mode for a predetermined time so as to receive key input. In step 612, it is checked whether or not there is the key input within the predetermined time. Then, the process proceeds to step 614.

In step 614, it is checked whether or not the inputted key is a “basic/extra camera selection key”. If the inputted key is the camera selection key, the process proceeds to step 616. Meanwhile, if not, the process proceeds to step 618. In step 616, the photographing camera is changed. If the current photographing camera is the basic camera, it is changed to the extra camera. If the current photographing camera is the extra camera, it is changed to the basic camera. In addition, the images photographed by the changed camera can be previewed. After these operations, the process returns to step 612 and the above steps are repeatedly performed.

Meanwhile, in step 616, it is checked whether or not the inputted key is a “photographed image storage key”. If the inputted key is the photographed image storage key, the process proceeds to step 619. If not, the process proceeds to the step 620 so that a function corresponding to the inputted key is performed. In step 619, frames of the images currently taken are stored after a compression image process of proper format. Then, the process returns to step 612 and the above steps can be repeatedly performed.

As stated above, structure and operation according to the embodiment of the present invention may be achieved. It will be apparent to those skilled in the art that various modifications and variations can be made within the scope of the present invention. For example, in accordance with another embodiment of the present invention, a mobile communication terminal with a plurality of display units like a dual-folder type handheld terminal can have the imaging device arrays such as the basic CCD device 410 and the additional CCD device 410-2 formed extendedly on the substrate of the plurality of display units. Also, one of a plurality of imaging device arrays is selected according to the camera selection manipulation to perform the photographing, and then the photographed images can be previewed on the LCD of the display unit on which the corresponding imaging device is provided. In addition, in the image storage manipulation, the photographed images taken currently can be stored after the compression image process of a proper format. Further, by separately selecting the respective imaging device array and the respective display unit, the photographed images of the selected imaging device array can be previewed on the LCD of the display unit as selected.

As described above, in accordance with the present invention, the mobile communication terminal with the built-in digital camera does not need the conventional additional connection units required for the external detachable camera module, thereby satisfying the demands for miniaturization and reduction in weight. In addition, since the camera module is provided in the display unit of the terminal, it is possible to prevent the degradation of image signals generated by the camera as well as the introduction of noise.

Further, since the camera module 210 of the present invention directly transmits the RGB data to the LCD 227, a fast frame rate can be obtained so that the image pictures can be displayed on the LCD 227 almost in real time.

While the invention has been shown and described with reference to certain preferred embodiments thereof, it will be understood by those of skill in the art that various changes in form and detail may be made therein without departing from the spirit and scope of the invention, as defined by the appended claims and equivalents thereof.

What is claimed is:

1. A mobile communication terminal with a built-in digital camera, comprising:
a liquid crystal display (LCD) for displaying various operation states of the terminal and photographed images; and
a camera module including a first imaging device,
wherein the LCD and the first imaging device are formed on a display unit.

2. The mobile communication terminal as claimed in claim 1, wherein the camera module further includes a second imaging device formed on other display unit than the display unit on which the first imaging device is formed.

3. The mobile communication terminal as claimed in claim 2, wherein the first imaging device is formed on an inner side of a folder of the terminal and a second imaging device is formed on an outer side of the folder.

4. The mobile communication terminal as claimed in claim 2, wherein the camera module processes image data detected by the second imaging device to generate RGB data, and the RGB data are directly provided to the LCD.

5. The mobile communication terminal as claimed in claim 3, wherein the first imaging device and the second imaging device are positioned to face in opposite directions.

6. The mobile communication terminal as claimed in claim 1, wherein the camera module processes image data detected by the first imaging device to generate RGB data, and the RGB data are directly provided to the LCD.

7. The mobile communication terminal as claimed in claim 1, wherein the camera module includes:
an imaging device pixel array for converting inputted light signals into electric signals;
a correlated double sampling/auto gain control (CDS/AGC) unit for performing a correlated double sampling of the signals outputted from the imaging device pixel array and performing a gain control thereof;
an analog-to-digital converter (ADC) for converting the signals outputted from the CDS/AGC unit into digital signals; and
an image processing unit for performing a gamma correction and a color calibration of the signals outputted from the ADC to generate RGB data to the LCD.

8. A camera module for a digital camera, the digital camera being built-in to a mobile communication terminal, comprising:
an imaging device pixel array for converting inputted light signals into electric signals;
a correlated double sampling/auto gain control (CDS/AGC) unit for performing a correlated double sampling of the signals outputted from the imaging device pixel array and performing a gain control thereof;
an analog-to-digital converter (ADC) for converting the signals outputted from the CDS/AGC unit into digital signals; and
an image processing unit for performing a gamma correction and a color calibration of the signals outputted from the ADC to generate RGB data to the LCD of the terminal.

9. A mobile communication terminal with a built-in digital camera, comprising:
a liquid crystal display (LCD) for displaying various operation states of the terminal and photographed images;
a camera module including: a first imaging device formed on a display unit; a second imaging device formed on other display unit than the display unit on which the first imaging device is formed; a switch for selectively switching between signals outputted from the first and second imaging devices according to a control signal and for outputting the selected signals; and an image processing unit for receiving the signals outputted from the switch and processing image data detected by the first or second imaging devices; and
a control unit for outputting the control signal to the switch in accordance with a predetermined camera selection.

10. The mobile communication terminal as claimed in claim 9, wherein the first imaging device is formed on an inner side of a folder of the terminal and the second imaging device is formed on an outer side of the folder.

11. The mobile communication terminal as claimed in claim 10, wherein the first imaging device and the second imaging device are positioned to face in opposite directions.

12. The mobile communication terminal as claimed in claim 9, wherein the image processing unit of the camera module processes image data detected by the first or second imaging devices to generate RGB data, and the RGB data are directly provided to the LCD.

13. A photographing method of a mobile communication terminal with a plurality of imaging devices and at least one display unit, comprising the steps of:
selecting one of a plurality of imaging devices according to a predetermined camera selection;
performing a preview operation by processing light signals detected from the selected imaging device into RGB data and displaying the RGB data on the LCD; and
performing a compression image processing of the RGB data and storing the processed data according to a predetermined image storage selection.

14. A photographing method of a mobile communication terminal with a plurality of display units, wherein an imaging device and an LCD for displaying various operation states of the terminal and photographed images are formed on a display unit, comprising the steps of:
selecting an imaging device according to a camera selection made by a user;
performing a preview operation for displaying a photographed image by processing light signals detected from the selected imaging device into RGB data and transmitting the RGB data to the LCD of a selected display unit; and
performing a compression image processing of the RGB data and storing the processed data according to a predetermined image storage selection.
